(19) United States
(12) Patent Application Publication
(10) Pub. No.: US 2007/0242746 A1
(43) Pub. Date: Oct. 18, 2007

(54) Video signal processing device

(76) Inventors: Takehiro Kishimoto, Osaka (JP); Toshiki Tada, Osaka (JP)

Correspondence Address: MCDERMOTT WILL & EMERY LLP, 600 13TH STREET, NW, WASHINGTON, DC, 20005-3096, US

(21) Appl. No.: 11/783,129

(22) Filed: Apr. 6, 2007

(30) Foreign Application Priority Data
Apr. 12, 2006 (JP) 2006-109518

(51) Int. Cl. H04B 1/66

(52) U.S. Cl. 375/240

(57) ABSTRACT

A video signal processing section decodes encoded moving picture data. A picture adjustment section performs an adjustment process on the decoded moving picture data. A picture compression section compresses the moving picture data adjusted by the picture adjustment section. If the moving picture data divided by a compression process size includes an effective video size region and a region other than the effective video size region, the picture adjustment section performs an adjustment on a pixel outside the effective video size region using a pixel inside the effective video size region.

### CROSS-REFERENCE TO RELATED APPLICATION(S)

This application claims priority under 35 U.S.C. §119(a) on Japanese Patent Application No. 2006 −109518 filed on Apr. 12, 2006, the entire contents of which are hereby incorporated by reference.

### BACKGROUND OF THE INVENTION

1. Field of the Invention

The present invention relates to a video signal processing device for decoding and reproducing encoded moving picture data and specifically to picture compression and expansion of moving picture data including groups of pixels outside an effective video size region.

2. Description of the Prior Art

In recent years, devices for reproducing encoded moving picture data using a picture information compressing method, such as MPEG (Moving Picture Experts Group), or the like, have been in competition for lower price and have been subjected to a demand for reduction in system cost. An existing solution for cost reduction is to reduce the capacity of a frame memory for storing moving picture data by reducing the amount of data as to encoded moving picture data using frequency conversion, or the like.

FIG. 7 shows a structure of a conventional video signal processing device. In FIG. 7, a video signal processing section 405 includes a variable-length decoder 401, a motion compensator 402, an inverse quantizer 403, and an IDCT (Inverse Discrete Cosine Transform) section 404. A picture compression section 407 includes a DCT (Discrete Cosine Transform) section, an IDCT section, etc. A picture expansion section 408 includes a DCT section, an IDCT section, etc.

The video signal processing device of FIG. 7 operates as follows. First, moving picture data 410 encoded based on MPEG2, or the like, is input to the video signal processing section 405. The video signal processing section 405 performs a decoding process on the moving picture data 410 to output moving picture data 411. Then, the picture compression section 407 performs a compressing process on the moving picture data 411 to output compressed moving picture data 413. The moving picture data 411 is divided by a DCT size of the DCT section of the picture compression section 407 and sequentially supplied to the picture compression section 407. The compressed moving picture data 413 output from the picture compression section 407 is stored in a frame memory 409. Compressed moving picture data 414 required for the video signal processing section 405 is retrieved from the frame memory 409 and subjected to an expansion process in the picture expansion section 408. Expanded moving picture data 415 is input to the video signal processing section 405 (see, for example, Japanese Laid-Open Patent Publication No. 9 −247673).

In the fields of picture information compression, various compression techniques including MPEG systems have been developed in recent years, resulting in various effective video sizes of moving picture data. Thus, some types of moving picture data have effective video sizes indivisible by a compression process size, such as a DCT size, and the like.

In the case of such moving picture data, there is a probability that the pixels which are subjected to compression include pixels outside the region of an effective video size. Specifically, there is a probability that moving picture data divided by a compression process size includes an effective video size region and a region other than the effective video size region. In this case, there is a possibility that the picture quality of compressed moving picture data deteriorates.

A possible solution to this problem is to perform compression with a DCT size changed according to the effective video size. However, this case results in not only a large operation circuit of the DCT section but also complicated control for circuitry. These lead to an increase in circuit size.

### SUMMARY OF THE INVENTION

An objective of the present invention is to provide a video signal processing device capable of operating on various effective video sizes of moving picture data inputs, wherein deterioration in picture quality of compressed moving picture data is suppressed without causing significant increase in circuit size.

A video signal processing device according to the present invention includes: a video signal processing section for decoding encoded moving picture data; a picture adjustment section for performing an adjustment process on moving picture data output from the video signal processing section; a picture compression section for compressing moving picture data adjusted by the picture adjustment section; and a picture expansion section for expanding moving picture data compressed by the picture compression section, wherein if the moving picture data divided by a compression process size includes an effective video size region and a region other than the effective video size region, the picture adjustment section performs an adjustment on a pixel outside the effective video size region using a pixel inside the effective video size region.

According to the present invention, the picture adjustment section performs an adjustment process on decoded moving picture data before compression by the picture compression section. In this adjustment process, if the moving picture data divided by a compression process size includes an effective video size region and a region other than the effective video size region, the picture adjustment section performs an adjustment on a pixel outside the effective video size region using a pixel inside the effective video size region. With such a structure, the correlation between the pixel group inside the effective video size region and the pixel group outside the effective video size region is increased, and therefore, deterioration in picture quality of moving picture data after compression is significantly reduced. Further, this adjustment process can be realized with a slight increase in circuit size.

A video signal processing device according to the present invention includes: a video signal processing section for decoding encoded moving picture data; a picture compression section for compressing moving picture data output from the video signal processing section; a picture expansion section for expanding moving picture data compressed by the picture compression section, and a picture adjustment section for performing an adjustment process on moving picture data output from the picture expansion section while referring to moving picture data output from the video signal processing section, wherein if the moving picture data divided by a compression process size and output from the video signal processing section includes an effective video size region and a region other than the effective video size region, the picture adjustment section stores in a temporary memory k pixels inside the effective video size region adjacent to a border with the region other than the effective video size region (k is a positive integer): and the picture adjustment section performs the adjustment process on the moving picture data output from the picture expansion section such that the k pixels stored in the temporary memory substitute for corresponding pixels of the moving picture data.

### EFFECTS OF THE INVENTION

According to the present invention, in compression of moving picture data decoded by a video signal processing section, an adjustment process is performed, whereby deterioration in picture quality of compressed moving picture data is significantly reduced. Further, an adjustment process is performed before compression, and in this case, it is not necessary to produce an operator adapted to an effective video size region. Thus, increase in circuit size can be prevented.

### BRIEF DESCRIPTION OF THE DRAWINGS

FIG. 1 is a block diagram showing a structure of a video signal processing device according to embodiments 1 to 12 of the present invention.

FIG. 2 is a schematic diagram illustrating row data subjected to an adjustment process.

FIG. 3 illustrates a compression expansion function.

FIG. 4 illustrates a compression expansion matrix where effective video size region m=4.

FIG. 5 shows an example of a structure of a picture adjustment section.

FIG. 6 is a block diagram showing a structure of a video signal processing device according to embodiment 13 of the present invention.

FIG. 7 is a block diagram showing a structure of a conventional video signal processing device.

### DESCRIPTION OF THE PREFERRED EMBODIMENTS

Hereinafter, embodiments of the present invention will be described with reference to the drawings.

### Embodiment 1

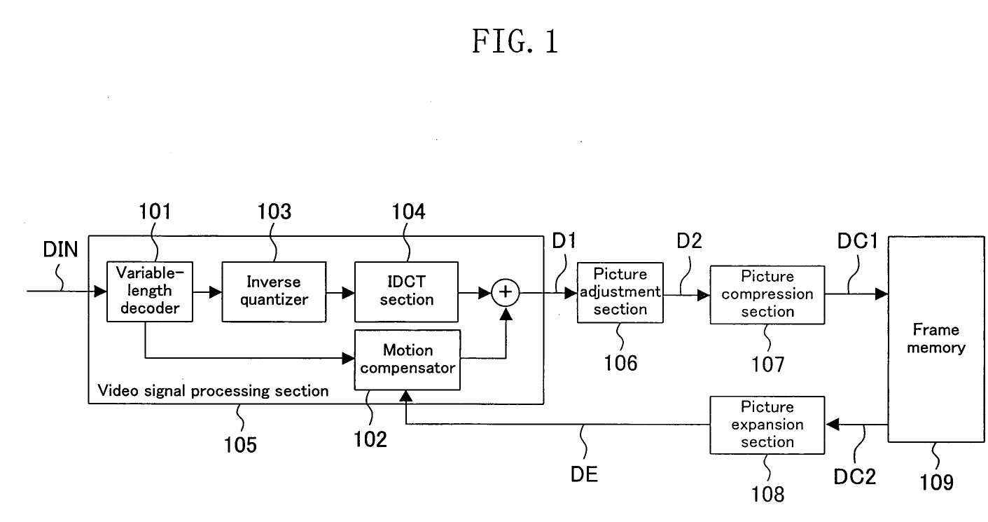

FIG. 1 is a block diagram showing a structure of a video signal processing device according to embodiment 1 of the present invention. Referring to FIG. 1, the video signal processing device includes a video signal processing section 105 for decoding encoded moving picture data DIN, a picture adjustment section 106 for performing an adjustment process on moving picture data D1 output from the video signal processing section 105, a picture compression section 107 for compressing moving picture data D2 adjusted by the picture adjustment section 106, and a picture expansion section 108 for expanding moving picture data DC2 compressed by the picture compression section 107. The video signal processing section 105 includes a variable-length decoder 101, a motion compensator 102, an inverse quantizer 103, and an IDCT section 104. The picture compression section 107 and the picture expansion section 108 perform processes using frequency conversion. The picture compression section 107 includes a DCT section, an IDCT section, etc. The picture expansion section 108 includes a DCT section, an IDCT section, etc.

Moving picture data DC1 compressed by the picture compression section 107 is accumulated in a frame memory 109. Compressed moving picture data DC2 required for the video signal processing section 105 is retrieved from the frame memory 109 and expanded by the picture expansion section 108. Expanded moving picture data DE is supplied to the video signal processing section 105. The video signal processing device of embodiment 1 does not include the frame memory 109 but may include the frame memory 109.

An operation of the video signal processing device having the structure shown in FIG. 1 is now described.

First, encoded moving picture data DIN is input to the video signal processing section 105. The video signal processing section 105 performs a decoding process. Moving picture data D1 decoded by the video signal processing section 105 is divided by a compression process size of the picture compression section 107 and input to the picture adjustment section 106. Herein, it is assumed that moving picture data D1 is divided by a DCT size of the DCT section.

In the case where moving picture data D1 divided by the compression process size includes an effective video size region and a region other than the effective video size region, the picture adjustment section 106 performs an adjustment process on pixels outside the effective video size region using pixels inside the effective video size region. This adjustment reduces deterioration in picture quality of moving picture data in data compression and expansion. Namely, the picture adjustment process performed prior to a picture compression process enhances the correlation between the pixels inside the effective video size region and the pixels outside the effective video size region. Details of the adjustment process will be described later.

Moving picture data D2 adjusted by the picture adjustment section 106 is input to the picture compression section 107. The picture compression section 107 performs a compression process to output compressed moving picture data DC1. This compression process reduces the amount of data. Compressed moving picture data DC1 output from the picture compression section 107 is accumulated in the frame memory 109. Then, compressed moving picture data DC2 required for the video signal processing section 105 is retrieved from the frame memory 109 and input to the picture expansion section 108. The picture expansion section 108 performs an expansion process to output expanded moving picture data DE. Expanded moving picture data DE output from the picture expansion section 108 is input to the video signal processing section 105 and used for motion compensation.

<Adjustment Process>

The picture adjustment section 106 performs an adjustment process on a row-by-row basis where each row includes a group of effective pixels inside an effective video size region and a group of adjustment subject pixels outside the effective video size region, these pixels being horizontally aligned in a row. (Herein, an “adjustment subject pixel” refers to a pixel which is to be adjusted by the picture adjustment section 106.) It should be noted that, although in this example the direction of the row is the horizontal direction, the arrangement of the pixels in each row is not limited to the horizontal direction. For example, it may be set in a different direction (e.g., a vertical direction) according to the specifications of the video signal processing device.

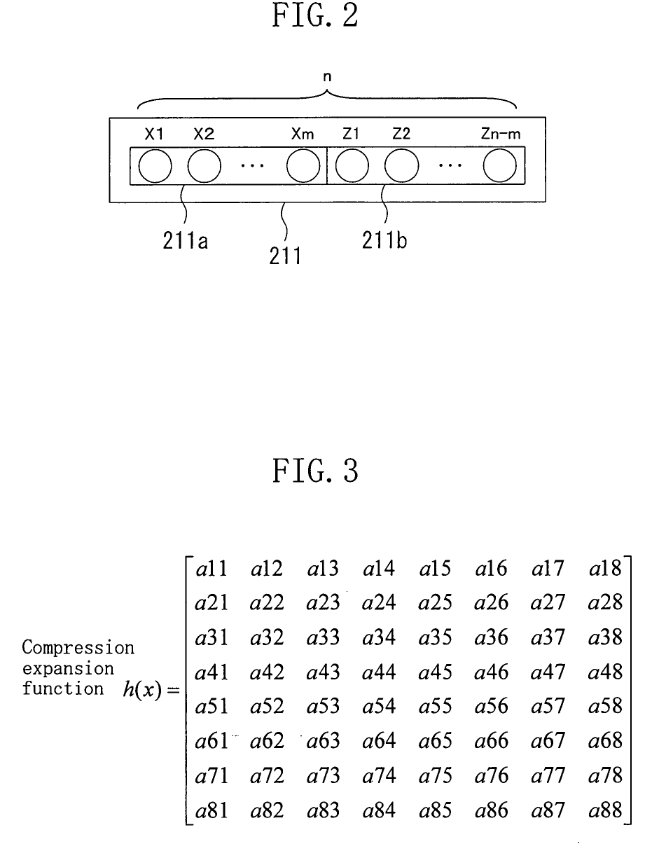

FIG. 2 is a schematic diagram illustrating row data subjected to an adjustment process. Referring to FIG. 2, row data 211 includes n pixels, consisting of an effective pixel group 211a inside an effective video size region, [X₁ X₂ . . . Xₘ], and an adjustment subject pixel group 211b outside the effective video size region, [Z₁ Z₂ . . . Zₙ₋ₘ]. Herein, n is equivalent to the compression process size (horizontal) and is an integer equal to or greater than 1, m represents the number of pixels of the effective pixel group 211a and is an integer equal to or greater than 1.

The picture adjustment section 106 adjusts the adjustment subject pixel group 211b [Z₁ Z₂ . . . Zₙ₋ₘ] using the effective pixel group 211a [X₁ X₂ . . . Xₘ]. As a result of this adjustment, deterioration in picture quality of compressed moving picture data DC1 is greatly reduced.

Specifically, the adjustment process of embodiment 1 is carried out such that each pixel of the adjustment subject pixel group 211b [Z₁ Z₂ . . . Zₙ₋ₘ] is replaced with pixel Xₘ at the trailing end of the effective pixel group 211a [X₁ X₂ . . . Xₘ]. Such an adjustment process prevents occurrence of a change in picture frequency at the border of the effective video size region and decreases generation of block noise.

Now, consider a case where the compression size (n) is 8, and the number of pixels of the effective pixel group 211a (m) is 4. In this case, the row data 211, [X₁ X₂ X₃ X₄ Z₁ Z₂ Z₃ Z₄], is adjusted such that each of Z₁ to Z₄ is replaced with X₄, resulting in [X₁ X₂ X₃ X₄ X₄ X₄ X₄ X₄].

The effect of improving the picture quality through the adjustment process is evaluated as follows.

For example, moving picture data is compressed to a ½ before accumulated in the frame memory 109. For video output, the compressed data is expanded twofold, i.e., expanded by the same factor to the original moving picture data size. Further, in the case where moving picture data required for the video signal processing section 105 is retrieved from the frame memory 109, the compressed moving picture data need to be expanded to the original pixel format.

In view of such circumstances, in embodiment 1, the evaluation of the adjustment process is carried out not using the pixel values of the frame memory 109 but using moving picture data expanded after compression. Where the compression function of the picture compression section 107 is f(x) and the expansion function of the picture expansion section 108 is g(x), the compression expansion function h(x) which is used for calculation of the pixel value after compression and expansion is obtained by multiplication of the compression function f(x) and the expansion function g(x). Use of this compression expansion function h(x) enables evaluation of the effect of improvement through the adjustment process.

In embodiment 1, the compression expansion function h(x) is defined as shown in FIG. 3. In the case where the row data 211 [X₁ X₂ X₃ X₄ Z₁ Z₂ Z₃ Z₄] is subjected to the compression expansion function h(x), the resultant pixel Yᵢ (i=1 to 8) is calculated as follows (where n=8 and m=4):

Yᵢ=(a1i×X₁+a2i×X₂+ . . . +a8i×Z₄)/100

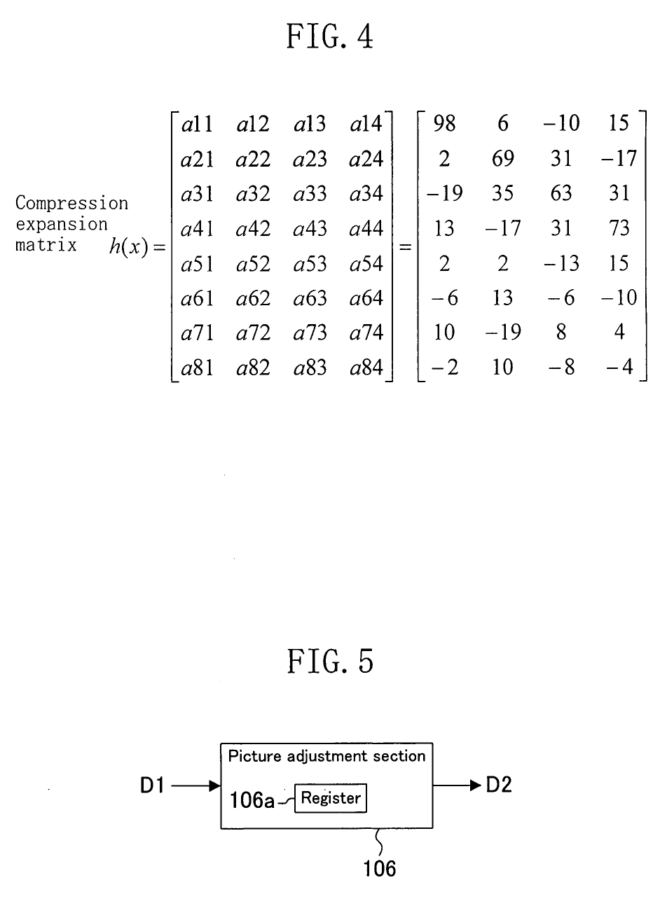

It should be noted that coefficients aj5, aj6, aj7, and aj8 (j=1 to 8) which are only necessary for the operations of Y₅ to Y₈ are not required herein because the evaluation is only necessary for the effective pixel group 211a [X₁ X₂ X₃ X₄]. Thus, the compression expansion function h(x) shown in FIG. 4 is used in the subsequent evaluation.

First, consider a case where the effective pixel group 211a monotonously increases and the adjustment subject pixel group 211b is 0, for example, the row data 211=[70 85 120 150 0 0 0 0]. In this case, the row data 211 is adjusted through the adjustment process of embodiment 1, resulting in [70 85 120 150 150 150 150 150]. The data obtained after compression and expansion results in [73 88 113 150 150 158 147 151], whereas the conventional process without adjustment would result in [67 79 141 143 11 0 8 0] after compression and expansion. As a result, the error from the effective pixel group 211a [70 85 120 150] is [3 3 −7 0] in embodiment 1, whereas [−3 −6 21 −7] in the conventional process. This result confirms that this embodiment provides the effect of improving the picture quality. It should be noted that moving picture data is originally given in the form of positive integers, and compressed moving picture data and expanded moving picture data are also in the form of positive integers. Herein, resolution comparison is expressed simply by the result of an operation with a picture compression matrix.

Consider another case where the adjustment subject pixel group 211b is 255, for example, the row data 211=[70 85 120 150 255 255 255 255]. The row data 211 is adjusted through the adjustment process of embodiment 1, resulting in [70 85 120 150 150 150 150 150]. In this case, the error of data obtained after compression and expansion from the effective pixel group 211a [70 85 120 150] is [3 3 −7 0] in this embodiment, whereas [7 10 −27 6] in the conventional process. This result confirms that this embodiment provides the effect of improving the picture quality.

Consider still another case where the adjustment subject pixel group 211b have random values, for example, the row data 211=[70 85 120 150 187 73 158 170]. The row data 211 is adjusted through the adjustment process of embodiment 1, resulting in [70 85 120 150 150 150 150 150]. In this case, the error of data obtained after compression and expansion from the effective pixel group 211a [70 85 120 150] is [3 3 −7 0] in this embodiment, whereas [9 5 −8 13] in the conventional process. This result confirms that this embodiment provides the effect of improving the picture quality.

Consider still another case where the pixel value of the effective pixel group 211a increases and decreases, for example, the row data 211=[40 80 60 50 0 0 0 0]. The row data 211 is adjusted through the adjustment process of embodiment 1, resulting in [40 80 60 50 50 50 50 50]. In this case, the error of data obtained after compression and expansion from the effective pixel group 211a [40 80 60 50] is [−2 −7 5 0] in this embodiment, whereas [−4 −10 14 −3] in the conventional process. This result confirms that this embodiment provides the effect of improving the picture quality.

### Embodiment 2

The structure of a video signal processing device according to embodiment 2 of the present invention is the same as that of embodiment 1. However, embodiment 2 is different from embodiment 1 as to the details of the adjustment process performed in the picture adjustment section 106.

Specifically, the adjustment process of embodiment 2 in the picture adjustment section 106 is carried out such that the adjustment subject pixel group 211b [Z₁ Z₂ . . . Zₙ₋ₘ] is adjusted by symmetric interpolation of the effective pixel group 211a [X₁ X₂ . . . Xₘ]. Herein, the symmetric interpolation refers to an adjustment of the adjustment subject pixel group 211b such that the effective pixel group 211a and the adjustment subject pixel group 211b are symmetrical about the border between the effective pixel group 211a and the adjustment subject pixel group 211b. This adjustment process achieves approximation in the picture frequency characteristics and pixel average value between the inside and outside of the effective video size region, thereby reducing deterioration in picture quality of moving picture data due to compression and expansion.

Where n=8 and m=4 as in embodiment 1, the row data 211 [X₁ X₂ X₃ X₄ Z₁ Z₂ Z₃ Z₄] is adjusted such that Z₁ to Z₄ are respectively replaced with X₄ to X₁, resulting in [X₁ X₂ X₃ X₄ X₄ X₃ X₂ X₁].

The effect of improving the picture quality by the adjustment process of embodiment 2 is now evaluated.

First, consider a case where the effective pixel group 211a monotonously increases and the adjustment subject pixel group 211b is 0, for example, the row data 211=[70 85 120 150 0 0 0 0]. In this case, the row data 211 is adjusted through the adjustment process of embodiment 2, resulting in [70 85 120 150 150 120 85 70]. The data obtained after compression and expansion results in [70 89 116 154 147 101 82 72], whereas the conventional process without adjustment would result in [67 79 141 143 11 0 8 0] after compression and expansion. As a result, the error from the effective pixel group 211a [70 85 120 150] is [0 4 −4 4] in embodiment 2, whereas [−3 −6 21 −7] in the conventional process. This result confirms that this embodiment provides the effect of improving the picture quality.

Consider another case where the adjustment subject pixel group 211b is 255, for example, the row data 211=[70 85 120 150 255 255 255 255]. The row data 211 is adjusted through the adjustment process of embodiment 2, resulting in [70 85 120 150 150 120 85 70]. In this case, the error of data obtained after compression and expansion from the effective pixel group 211a [70 85 120 150] is [0 4 −4 4] in this embodiment, whereas [7 10 −27 6] in the conventional process. This result confirms that this embodiment provides the effect of improving the picture quality.

Consider still another case where the adjustment subject pixel group 211b have random values, for example, the row data 211=[70 85 120 150 187 73 158 170]. The row data 211 is adjusted through the adjustment process of embodiment 2, resulting in [70 85 120 150 150 120 85 70]. In this case, the error of data obtained after compression and expansion from the effective pixel group 211a [70 85 120 150] is [0 4 −4 4] in this embodiment, whereas [9 5 −8 13] in the conventional process. This result confirms that this embodiment provides the effect of improving the picture quality.

Consider still another case where the pixel value of the effective pixel group 211a increases and decreases, for example, the row data 211=[40 80 60 50 0 0 0 0]. The row data 211 is adjusted through the adjustment process of embodiment 2, resulting in [40 80 60 50 50 60 80 40]. In this case, the error of data obtained after compression and expansion from the effective pixel group 211a [40 80 60 50] is [1 −12 7 1] in this embodiment, whereas [−4 −10 14 −3] in the conventional process. This result confirms that this embodiment provides the effect of improving the picture quality.

### Embodiment 3

The structure of a video signal processing device according to embodiment 3 of the present invention is the same as that of embodiment 1. However, embodiment 3 is different from embodiment 1 as to the details of the adjustment process performed in the picture adjustment section 106. In embodiment 3, a different between pixels in the vicinity of the border of the effective pixel group is utilized to consider the tendency of change in pixel value (i.e., whether the pixel value increases or decreases).

Specifically, the picture adjustment section 106 of embodiment 3 carries out the following adjustment process. First, pixel Z₁ of the adjustment subject pixel group 211b, which is adjacent to the effective pixel group, is adjusted using two pixels Xₘ₋₁ and Xₘ at the trailing end of the effective pixel group 211a, resulting in 2Xₘ-Xₘ₋₁. Namely,

Z₁=2Xₘ−Xₘ₋₁=Xₘ+(Xₘ−Xₘ₋₁),

in which the tendency of change in pixel value is considered. Then, the remaining pixels of the adjustment subject pixel group 211b, [Z₂ . . . Zₙ₋ₘ], are adjusted by symmetric interpolation of the effective pixel group 211a [X₁ X₂ . . . Xₘ] symmetrically about the adjusted pixel Z₁. Herein, the symmetric interpolation refers to an adjustment of the remaining pixels of the adjustment subject pixel group 211b such that the effective pixel group 211a and the adjustment subject pixel group 211b are symmetrical about pixel Z₁. This adjustment process achieves such an adjustment that the tendency of change in picture frequency of moving picture data is considered at the border of the effective video size region. Further, the symmetric interpolation achieves approximation in the picture frequency characteristics and pixel average value between the inside and outside of the effective video size region. Thus, the effect of reducing deterioration in picture quality of moving picture data due to compression and expansion is obtained.

Where n=8 and m=4 as in embodiment 1, the row data 211 [X₁ X₂ X₃ X₄ Z₁ Z₂ Z₃ Z₄] is adjusted such that Z₁ is replaced with 2*X₄−X₃ and Z₂ to Z₄ are respectively replaced with X₄ to X₂, resulting in [X₁ X₂ X₃ X₄ 2*X₄−X₃ X₄ X₃ X₂].

The effect of improving the picture quality by the adjustment process of embodiment 3 is now evaluated.

First, consider a case where the effective pixel group 211a monotonously increases and the adjustment subject pixel group 211b is 0, for example, the row data 211=[70 85 120 150 0 0 0 0]. In this case, the row data 211 is adjusted through the adjustment process of embodiment 3, so that Z₁=2×150−120=180, resulting in [70 85 120 150 180 150 120 85]. The data obtained after compression and expansion results in [72 88 112 156 172 164 112 90], whereas the conventional process without adjustment would result in [67 79 141 143 11 0 8 0] after compression and expansion. As a result, the error from the effective pixel group 211a [70 85 120 150] is [2 3 −8 6] in embodiment 3, whereas [−3 −6 21 −7] in the conventional process. This result confirms that this embodiment provides the effect of improving the picture quality.

Consider another case where the adjustment subject pixel group 211b is 255, for example, the row data 211=[70 85 120 150 255 255 255 255]. The row data 211 is adjusted through the adjustment process of embodiment 3, resulting in [70 85 120 150 180 150 120 85]. In this case, the error of data obtained after compression and expansion from the effective pixel group 211a [70 85 120 150] is [2 3 −8 6] in this embodiment, whereas [7 10 −27 6] in the conventional process. This result confirms that this embodiment provides the effect of improving the picture quality.

Consider still another case where the adjustment subject pixel group 211b have random values, for example, the row data 211=[70 85 120 150 187 73 158 170]. The row data 211 is adjusted through the adjustment process of embodiment 3, resulting in [70 85 120 150 180 150 120 85]. In this case, the error of data obtained after compression and expansion from the effective pixel group 211a [70 85 120 150] is [2 3 −8 6] in this embodiment, whereas [9 5 −8 13] in the conventional process. This result confirms that this embodiment provides the effect of improving the picture quality.

Consider still another case where the pixel value of the effective pixel group 211a increases and decreases, for example, the row data 211=[40 80 60 50 0 0 0 0]. The row data 211 is adjusted through the adjustment process of embodiment 3, resulting in [40 80 60 50 40 50 60 80]. In this case, the error of data obtained after compression and expansion from the effective pixel group 211a [40 80 60 50] is [−2 −6 4 −2] in this embodiment, whereas [−4 −10 14 −3] in the conventional process. This result confirms that this embodiment provides the effect of improving the picture quality.

### Embodiment 4

The structure of a video signal processing device according to embodiment 4 of the present invention is the same as that of embodiment 1. However, embodiment 4 is different from embodiment 1 as to the details of the adjustment process performed in the picture adjustment section 106.

Specifically, the adjustment process of embodiment 4 in the picture adjustment section 106 is carried out such that the adjustment subject pixel group 211b [Z₁ Z₂ . . . Zₙ₋ₘ] is adjusted by symmetric interpolation of the effective pixel group 211a [X₁ X₂ . . . Xₘ] symmetrically about pixel Xₘ at the trailing end of the effective pixel group 211a. This adjustment process achieves approximation in the picture frequency characteristics and pixel average value between the inside and outside of the effective video size region, thereby reducing deterioration in picture quality of moving picture data due to compression and expansion.

Where n=8 and m=4 as in embodiment 1, the row data 211 [X₁ X₂ X₃ X₄ Z₁ Z₂ Z₃ Z₄] is adjusted to be [X₁ X₂ X₃ X₄ X₃ X₂ X₁ X₂].

First, consider a case where the effective pixel group 211a monotonously increases and the adjustment subject pixel group 211b is 0, for example, the row data 211=[70 85 120 150 0 0 0 0]. In this case, the row data 211 is adjusted through the adjustment process of embodiment 4, resulting in [70 85 120 150 120 85 70 85]. The data obtained after compression and expansion results in [69 87 121 151 118 88 70 85], whereas the conventional process without adjustment would result in [67 79 141 143 11 0 8 0] after compression and expansion. As a result, the error from the effective pixel group 211a [70 85 120 150] is [−1 2 1 1] in embodiment 4, whereas [−3 −6 21 −7] in the conventional process. This result confirms that this embodiment provides the effect of improving the picture quality.

Consider another case where the adjustment subject pixel group 211b is 255, for example, the row data 211=[70 85 120 150 255 255 255 255]. The row data 211 is adjusted through the adjustment process of embodiment 4, resulting in [70 85 120 150 120 85 70 85]. In this case, the error of data obtained after compression and expansion from the effective pixel group 211a [70 85 120 150] is [−1 2 1 1] in this embodiment, whereas [7 10 −27 6] in the conventional process. This result confirms that this embodiment provides the effect of improving the picture quality.

Consider still another case where the adjustment subject pixel group 211b have random values, for example, the row data 211=[70 85 120 150 187 73 158 170]. The row data 211 is adjusted through the adjustment process of embodiment 4, resulting in [70 85 120 150 120 85 70 85]. In this case, the error of data obtained after compression and expansion from the effective pixel group 211a [70 85 120 150] is [−1 2 1 1] in this embodiment, whereas [9 5 −8 13] in the conventional process. This result confirms that this embodiment provides the effect of improving the picture quality.

Consider still another case where the pixel value of the effective pixel group 211a increases and decreases, for example, the row data 211=[40 80 60 50 0 0 0 0]. The row data 211 is adjusted through the adjustment process of embodiment 4, resulting in [40 80 60 50 50 60 80 40]. In this case, the error of data obtained after compression and expansion from the effective pixel group 211a [40 80 60 50] is [−5 1 −2 −4] in this embodiment, whereas [−4 −10 14 −3] in the conventional process. This result confirms that this embodiment provides the effect of improving the picture quality.

### Embodiment 5

The structure of a video signal processing device according to embodiment 5 of the present invention is the same as that of embodiment 1. However, embodiment 5 is different from embodiment 1 as to the details of the adjustment process performed in the picture adjustment section 106.

Specifically, the picture adjustment section 106 of embodiment 5 carries out the following adjustment process. First, pixel Z₁ of the adjustment subject pixel group 211b, which is adjacent to the effective pixel group, is adjusted to have a value calculated by a function based on k pixels at the trailing end of the effective pixel group 211a (k is an integer equal to or greater than 3). Then, the remaining pixels of the adjustment subject pixel group 211b, [Z₂ . . . Zₙ₋ₘ], are adjusted by symmetric interpolation of the effective pixel group 211a [X₁ X₂ . . . Xₘ] symmetrically about the adjusted pixel Z₁.

The above function is such that the difference between pixels multiplied by a coefficient is added to the pixel at the trailing end of the effective pixel group 211a. Preferably, the coefficient becomes smaller as it is more distant from the adjusted pixel Z₁. As a result, the weight on the variation between pixels near the adjusted pixel Z₁ is larger, while the weight on the variation between pixels distant from the adjusted pixel Z₁ is smaller. This adjustment process achieves an adjustment of the first pixel of the adjustment subject pixel group in consideration of the picture frequency characteristics inside the effective video size region. Further, the symmetric interpolation of the effective pixel group enables an adjustment in consideration of the overall picture frequency characteristics and pixel average value. Thus, the effect of reducing deterioration in picture quality of moving picture data due to compression and expansion is obtained.

It is assumed herein that n=8, m=5, and k=3. Namely, pixel Z₁ is adjusted using a function based on three pixels at the trailing end of the effective pixel group 211a, [X₃ X₄ X₅]. The coefficients applied to the differences between pixels are ¾ and ¼ in the order of closeness to pixel Z₁. Thus, pixel Z₁ is adjusted such that Z₁=X₅+(X₅−X₄)*¾+(X₄−X₃)*¼.

The effect of improving the picture quality by the adjustment process of embodiment 5 is now evaluated.

Now, consider a case where the adjustment subject pixel group 211b is 0, for example, the row data 211=[80 90 100 120 110 0 0 0]. In this case, the row data 211 is adjusted through the adjustment process of embodiment 5, resulting in [80 90 100 120 110 108 110 120]. The data obtained after compression and expansion results in [81 88 98 120 118 45 110 121], whereas the conventional process without adjustment would result in [76 82 106 131 88 23 −17 8] after compression and expansion. As a result, the error from the effective pixel group 211a [80 90 100 120 110] is [1 −2 −2 0 1] in embodiment 5, whereas [−4 −8 6 11 −23] in the conventional process. This result confirms that this embodiment provides the effect of improving the picture quality.

It should be noted that the coefficients applied to the difference between pixels are not limited to the set of ¾ and ¼. The number of pixels used for the function, k, is not limited to 3.

As shown in FIG. 5, the picture adjustment section 106 may include a register 106a for storing the aforementioned coefficients of the function. This structure enables to arbitrarily change the set of coefficients, for example, from ¾ and ¼ to ⅔ and ⅓.

Thus, how much the rate of variation in effective pixels is considered can be determined according to the characteristics of moving picture data. Therefore, a more appropriate adjustment process can be realized.

### Embodiment 6

The structure of a video signal processing device according to embodiment 6 of the present invention is the same as that of embodiment 1. However, embodiment 6 is different from embodiment 1 as to the details of the adjustment process performed in the picture adjustment section 106.

Specifically, the adjustment process of embodiment 6 in the picture adjustment section 106 is carried out such that the adjustment subject pixel group 211b [Z₁ Z₂ . . . Zₙ₋ₘ] are replaced with the effective pixel group 211a [X₁ X₂ . . . Xₘ] in the original order. This adjustment process suppresses a change in frequency and a large variation in pixel average value near the border of the effective video size region. Thus, the effect of reducing deterioration in picture quality of moving picture data due to compression and expansion is obtained.

Where n=8 and m=4 as in embodiment 1, the row data 211 [X₁ X₂ X₃ X₄ Z₁ Z₂ Z₃ Z₄] is adjusted such that Z₁ to Z₄ are respectively replaced with X₁ to X₄, resulting in [X₁ X₂ X₃ X₄ X₁ X₂ X₃ X₄].

The effect of improving the picture quality by the adjustment process of embodiment 6 is now evaluated.

Now, consider a case where the effective pixel group 211a monotonously increases and the adjustment subject pixel group 211b is 0, for example, the row data 211=[70 85 120 150 0 0 0 0]. In this case, the row data 211 is adjusted through the adjustment process of embodiment 6, resulting in [70 85 120 150 70 85 120 150]. The data obtained after compression and expansion results in [74 84 121 143 78 81 124 146], whereas the conventional process without adjustment would result in [67 79 141 143 11 0 8 0] after compression and expansion. As a result, the error from the effective pixel group 211a [70 85 120 150] is [4 −1 1 −7] in embodiment 6, whereas [−3 −6 21 −7] in the conventional process. This result confirms that this embodiment provides the effect of improving the picture quality.

### Embodiment 7

The structure of a video signal processing device according to embodiment 7 of the present invention is the same as that of embodiment 1. However, embodiment 7 is different from embodiment 1 as to the details of the adjustment process performed in the picture adjustment section 106. The picture adjustment section 106 of embodiment 7 includes a register 106a as shown in FIG. 5 for storing an adjustment value which is to be used for an adjustment of the adjustment subject pixel group 211b.

Specifically, the adjustment process of embodiment 7 in the picture adjustment section 106 is carried out such that the adjustment subject pixel group 211b [Z₁ Z₂ . . . Zₙ₋ₘ] is adjusted to have the adjustment value stored in the register 106a. The adjustment value is set according to the features of moving picture data, whereby the level (high or low) of the picture frequency and the pixel average value can be changed. Thus, the effect of reducing deterioration in picture quality of moving picture data due to compression and expansion is obtained.

Assuming that n=8 and m=5 and that adjustment value [0 0 255] is stored in the register 106a, the row data 211 [X₁ X₂ X₃ X₄ X₅ Z₁ Z₂ Z₃] is adjusted such that Z₁, Z₂, and Z₃ are respectively replaced with 0, 0, and 255, resulting in [X₁ X₂ X₃ X₄ X₅ 0 0 255].

The effect of improving the picture quality by the adjustment process of embodiment 7 is now evaluated.

Now, consider a case where the effective pixel group 211a has large high frequency components and the adjustment subject pixel group 211b is 0, for example, the row data 211=[100 150 90 120 80 0 0 0]. In this case, the row data 211 is adjusted through the adjustment process of embodiment 7, resulting in [100 150 90 120 80 0 0 255]. The data obtained after compression and expansion results in [99 148 99 106 94 −33 7 249], whereas the conventional process without adjustment would result in [99 121 120 117 68 19 −19 10] after compression and expansion. As a result, the error from the effective pixel group 211a [100 150 90 120 80] is [−1 −2 9 −14 14] in embodiment 7, whereas [−1 −29 30 −3 −13] in the conventional process. This result confirms that this embodiment provides the effect of improving the picture quality.

### Embodiment 8

The structure of a video signal processing device according to embodiment 8 of the present invention is the same as that of embodiment 1. However, embodiment 8 is different from embodiment 1 as to the details of the adjustment process performed in the picture adjustment section 106. The picture adjustment section 106 of embodiment 8 includes a register 106a as shown in FIG. 5 for storing an adjustment value which is to be used in an operation for an adjustment of the adjustment subject pixel group 211b.

Specifically, the adjustment process of embodiment 8 in the picture adjustment section 106 is carried out as follows. First, pixel average value XAVE of the effective pixel group 211a [X₁ X₂ . . . Xₘ] is calculated. Then, the adjustment subject pixel group 211b [Z₁ Z₂ . . . Zₙ₋ₘ] is adjusted to have a value obtained by adding the adjustment value of the register 106a to pixel average value XAVE. Namely, this adjustment process achieves an adjustment using the pixel average value of the effective pixel group as a reference. Therefore, the adjustment subject pixel group can be adjusted to have a value approximate to the pixel average value. Thus, the effect of reducing deterioration in picture quality of moving picture data due to compression and expansion is obtained.

Assuming that n=8 and m=5 and that adjustment value [−10 20 10] is stored in the register 106a, the row data 211 [X₁ X₂ X₃ X₄ X₅ Z₁ Z₂ Z₃] is adjusted to be [X₁ X₂ X₃ X₄ X₅ XAVE-10 XAVE+20 XAVE+10] (where XAVE=(X₁+X₂+X₃+X₄+X₅)/5).

The effect of improving the picture quality by the adjustment process of embodiment 8 is now evaluated.

Now, consider a case where the adjustment subject pixel group 211b is 0, for example, the row data 211=[120 110 140 130 125 0 0 0]. In this case, the row data 211 is adjusted through the adjustment process of embodiment 8, resulting in [120 110 140 130 125 115 145 135]. The data obtained after compression and expansion results in [118 112 128 144 115 46 141 138], whereas the conventional process without adjustment would result in [110 111 134 156 95 23 −15 8] after compression and expansion. As a result, the error from the effective pixel group 211a [120 110 140 130 125] is [−2 2 −12 14 −10] in embodiment 8, whereas [−10 1 −6 26 −30] in the conventional process. This result confirms that this embodiment provides the effect of improving the picture quality.

### Embodiment 9

The structure of a video signal processing device according to embodiment 9 of the present invention is the same as that of embodiment 1. However, embodiment 9 is different from embodiment 1 as to the details of the adjustment process performed in the picture adjustment section 106. In embodiment 9, data of two rows precedent to a row which is to be adjusted are used for the adjustment.

Specifically, the adjustment process of embodiment 9 in the picture adjustment section 106 is carried out such that each pixel of the adjustment subject pixel group 211b is adjusted to be equal to the average of 2Xₗ−Xₗ₋₁ and 2Xₚ−Xₚ₋₁. Herein, Xₗ₋₁ and Xₗ represent two preceding pixels in the same row, Xₚ represents a pixel at the intersection of the immediately preceding row and the immediately preceding column, and Xₚ₋₁ represents a pixel at the intersection of the second preceding row and the second preceding column. In this embodiment, 2Xₗ−Xₗ₋₁ represents an adjustment value in which the tendency of change in pixel value of the immediately-preceding pixels is considered, and 2Xₚ−Xₚ₋₁ represents an adjustment value in which the tendency of change in pixel value of the diagonally adjoining upper pixels is considered. This adjustment process achieves an adjustment such that each pixel of the adjustment subject pixel group is adjusted using an adjustment value calculated for two directions, thereby improving the adjustment accuracy. Thus, the effect of reducing deterioration in picture quality of moving picture data due to compression and expansion is obtained.

The effect of improving the picture quality by the adjustment process of embodiment 9 is now evaluated.

Now, consider a case where the adjustment subject pixel group 211b is 0, for example, the row data 211=[115 125 130 130 120 0 0 0], the row data of the immediately preceding row is [115 130 135 135 130 0 0 0], and the row data of the second preceding row is [120 130 135 140 130 0 0 0]. In this case, the row data 211 is adjusted through the adjustment process of embodiment 9, resulting in [115 125 130 130 120 115 113 110]. The data obtained after compression and expansion results in [112 122 127 137 117 120 112 113], whereas the conventional process without adjustment would result in [107 118 134 149 93 24 −18 10] after compression and expansion. As a result, the error from the effective pixel group 211a [115 125 130 130 120] is [−3 −3 −3 7 −3] in embodiment 9, whereas [−8 −8 4 19 −27] in the conventional process. This result confirms that this embodiment provides the effect of improving the picture quality.

### Embodiment 10

The structure of a video signal processing device according to embodiment 10 of the present invention is the same as that of embodiment 1. However, embodiment 10 is different from embodiment 1 as to the details of the adjustment process performed in the picture adjustment section 106. In embodiment 10, data of two preceding rows and two subsequent rows of a row which is to be adjusted are used for the adjustment.

Specifically, the adjustment process of embodiment 10 in the picture adjustment section 106 is carried out such that each pixel of the adjustment subject pixel group 211b is adjusted to be equal to the average of 2Xₗ−Xₗ₋₁, 2Xₚ−Xₚ₋₁ and 2X_{q}−X_{q-1}. Herein, Xₗ₋₁, and Xₗ represent two preceding pixels in the same row, Xₚ represents a pixel at the intersection of the immediately preceding row and the immediately preceding column, Xₚ₋₁ represents a pixel at the intersection of the second preceding row and the second preceding column, X_{q} represents a pixel at the intersection of the immediately subsequent row and the immediately preceding column, and X_{q-1} represents a pixel at the intersection of the second subsequent row and the second preceding column. In this embodiment, 2Xₗ−Xₗ₋₁ represents an adjustment value in which the tendency of change in pixel value of the immediately-preceding pixels is considered, 2Xₚ−Xₚ₋₁ represents an adjustment value in which the tendency of change in pixel value of the diagonally adjoining upper pixels is considered, and 2X_{q}−X_{q-1} represents an adjustment value in which the tendency of change in pixel value of the diagonally adjoining lower pixels is considered. This adjustment process achieves an adjustment such that each pixel of the adjustment subject pixel group is adjusted using an adjustment value calculated for three directions, thereby improving the adjustment accuracy. Thus, the effect of reducing deterioration in picture quality of moving picture data due to compression and expansion is obtained.

The effect of improving the picture quality by the adjustment process of embodiment 10 is now evaluated.

Now, consider a case where the adjustment subject pixel group 211b is 0, for example, the row data 211=[115 125 130 130 120 0 0 0], the row data of the immediately preceding row is [115 130 135 135 130 0 0 0], the row data of the second preceding row is [120 130 135 140 130 0 0 0], the row data of the immediately subsequent row is [110 125 125 120 110 0 0 0], and the row data of the second subsequent row is [110 120 115 110 115 0 0 0]. In this case, the row data 211 is adjusted through the adjustment process of embodiment 10, resulting in [115 125 130 130 120 112 106 99]. The data obtained after compression and expansion results in [111 122 128 137 116 117 105 102], whereas the conventional process without adjustment would result in [107 118 134 149 93 24 −18 10] after compression and expansion. As a result, the error from the effective pixel group 211a [115 125 130 130 120] is [−4 −3 −2 7 −4] in embodiment 10, whereas [−8 −8 4 19-27] in the conventional process. This result confirms that this embodiment provides the effect of improving the picture quality.

### Embodiment 11

The structure of a video signal processing device according to embodiment 11 of the present invention is the same as that of embodiment 1. However, embodiment 11 is different from embodiment 1 as to the details of the adjustment process performed in the picture adjustment section 106. In embodiment 11, data of two rows precedent to a row which is to be adjusted are used for the adjustment.

Specifically, the adjustment process of embodiment 11 in the picture adjustment section 106 is carried out as follows. First, pixel Z₁ of the adjustment subject pixel group 211b, which is adjacent to the effective pixel group, is adjusted to be equal to the average of 2Xₘ−Xₘ₋₁ and 2Xₚ−Xₚ₋₁. Herein, Xₘ₋₁ and Xₘ represent two pixels at the trailing end of the effective pixel group 211a, Xₚ represents a pixel at the intersection of the immediately preceding row and the immediately preceding column, and Xₚ₋₁ represents a pixel at the intersection of the second preceding row and the second preceding column. In this embodiment, 2Xₘ−Xₘ₋₁ represents an adjustment value in which the tendency of change in pixel value of the immediately-preceding pixels is considered, and 2Xₚ−Xₚ₋₁ represents an adjustment value in which the tendency of change in pixel value of the diagonally adjoining upper pixels is considered. Then, the remaining pixels of the adjustment subject pixel group 211b are adjusted by symmetric interpolation of the effective pixel group 211a symmetrically about the adjusted pixel Z₁. This adjustment process achieves an adjustment such that a pixel of the adjustment subject pixel group which is adjacent to the effective pixel group is adjusted using an adjustment value calculated for two directions, thereby improving the adjustment accuracy. Thus, the effect of reducing deterioration in picture quality of moving picture data due to compression and expansion is obtained.

The effect of improving the picture quality by the adjustment process of embodiment 11 is now evaluated.

Now, consider a case where the adjustment subject pixel group 211b is 0, for example, the row data 211=[115 125 130 130 120 0 0 0], the row data of the immediately preceding row is [115 130 135 135 130 0 0 0], and the row data of the second preceding row is [120 130 135 140 130 0 0 0]. In this case, the row data 211 is adjusted through the adjustment process of embodiment 11, resulting in [115 125 130 130 120 115 120 130]. The data obtained after compression and expansion results in [112 123 126 136 118 120 119 132], whereas the conventional process without adjustment would result in [107 118 134 149 93 24 −18 10] after compression and expansion. As a result, the error from the effective pixel group 211a [115 125 130 130 120] is [−3 −2 −4 6 −2] in embodiment 11, whereas [−8 −8 4 19 −27] in the conventional process. This result confirms that this embodiment provides the effect of improving the picture quality.

### Embodiment 12

The structure of a video signal processing device according to embodiment 12 of the present invention is the same as that of embodiment 1. However, embodiment 12 is different from embodiment 1 as to the details of the adjustment process performed in the picture adjustment section 106. In embodiment 12, data of two preceding rows and two subsequent rows of a row which is to be adjusted are used for the adjustment.

Specifically, the adjustment process of embodiment 12 in the picture adjustment section 106 is carried out as follows. First, pixel Z₁ of the adjustment subject pixel group 211b, which is adjacent to the effective pixel group, is adjusted to be equal to the average of 2Xₘ−Xₘ₋₁, 2Xₚ−Xₚ₋₁ and 2X_{q}−X_{q-1}. Herein, Xₘ₋₁ and Xₘ represent two pixels at the trailing end of the effective pixel group 211a, Xₚ represents a pixel at the intersection of the immediately preceding row and the immediately preceding column, Xₚ₋₁ represents a pixel at the intersection of the second preceding row and the second preceding column, X_{q} represents a pixel at the intersection of the immediately subsequent row and the immediately preceding column, and X_{q-1} represents a pixel at the intersection of the second subsequent row and the second preceding column. In this embodiment, 2Xₘ−Xₘ₋₁ represents an adjustment value in which the tendency of change in pixel value of the immediately-preceding pixels is considered, 2Xₚ−Xₚ₋₁ represents an adjustment value in which the tendency of change in pixel value of the diagonally adjoining upper pixels is considered, and 2X_{q}−X_{q-1} represents an adjustment value in which the tendency of change in pixel value of the diagonally adjoining lower pixels is considered. Then, the remaining pixels of the adjustment subject pixel group 211b are adjusted by symmetric interpolation of the effective pixel group 211a symmetrically about the adjusted pixel Z₁. This adjustment process achieves an adjustment such that a pixel of the adjustment subject pixel group which is adjacent to the effective pixel group is adjusted using an adjustment value calculated for three directions, thereby improving the adjustment accuracy. Thus, the effect of reducing deterioration in picture quality of moving picture data due to compression and expansion is obtained.

The effect of improving the picture quality by the adjustment process of embodiment 12 is now evaluated.

Now, consider a case where the adjustment subject pixel group 211b is 0, for example, the row data 211=[115 125 130 130 120 0 0 0], the row data of the immediately preceding row is [1 15 130 135 135 130 0 0 0], the row data of the second preceding row is [120 130 135 140 130 0 0 0], the row data of the immediately subsequent row is [110 125 125 120 110 0 0 0], and the row data of the second subsequent row is [110 120 115 110 115 0 0 0]. In this case, the row data 211 is adjusted through the adjustment process of embodiment 12, resulting in [115 125 130 130 120 112 120 130]. The data obtained after compression and expansion results in [113 123 126 137 117 118 118 132], whereas the conventional process without adjustment would result in [107 118 134 149 93 24 −18 10] after compression and expansion. As a result, the error from the effective pixel group 211a [115 125 130 130 120] is [−2 −2 −4 7 −3] in embodiment 12, whereas [−8 −8 4 19-27] in the conventional process. This result confirms that this embodiment provides the effect of improving the picture quality.

### Embodiment 13

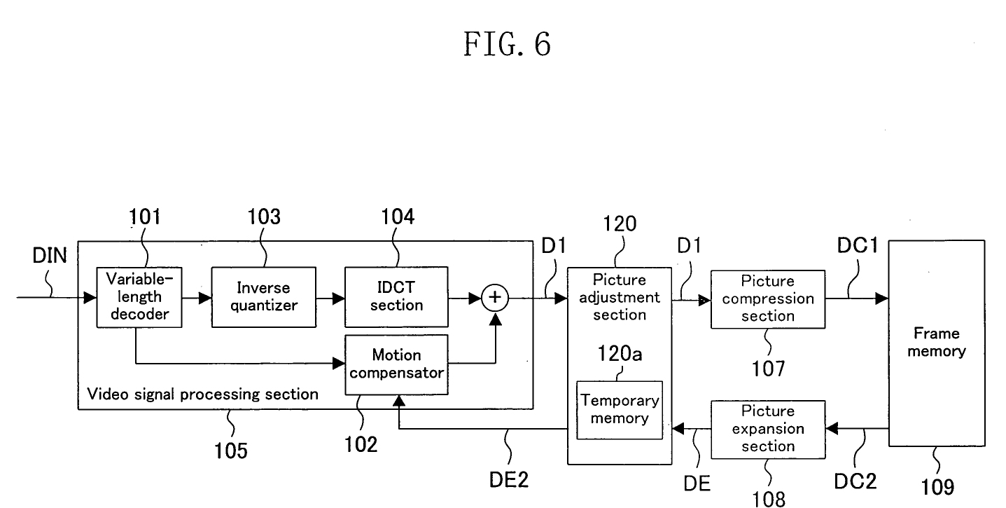

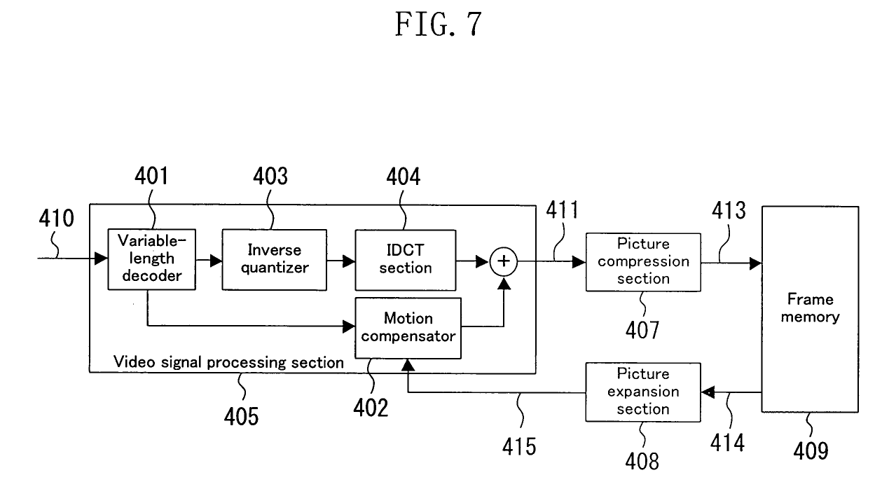

FIG. 6 is a block diagram showing a structure of a video signal processing device according to embodiment 13 of the present invention. In FIG. 6, elements equivalent to those of FIG. 1 are denoted by the same reference numerals used in FIG. 1, and the detailed descriptions of such elements are herein omitted.

Referring to FIG. 6, a picture adjustment section 120 performs an adjustment process on moving picture data DE output from the picture expansion section 108 and outputs adjusted moving picture data DE2 to the video signal processing section 105. In this process, the picture adjustment section 120 refers to moving picture data D1 output from the video signal processing section 105. The picture adjustment section 120 includes a temporary memory 120a.

Specifically, the adjustment process of embodiment 13 in the picture adjustment section 120 is carried out as follows. In the case where moving picture data D1 divided by the compression process size includes an effective video size region and a region other than the effective video size region, the picture adjustment section 120 stores in the temporary memory 120a k pixels inside the effective video size region which are adjacent to the border with the region other than the effective video size region (k is a positive integer). Then, the picture adjustment section 120 performs an adjustment on moving picture data DE output from the picture expansion section 108 such that the k pixels stored in the temporary memory 120a substitute for corresponding pixels of moving picture data DE. Since this adjustment process uses pixels before compression and expansion at the border of the effective video size region, the effect of reducing deterioration in picture quality of moving picture data due to compression and expansion is obtained.

The picture adjustment section 120 performs an adjustment process on a row-by-row basis where each row includes a group of effective pixels inside an effective video size region and a group of adjustment subject pixels outside the effective video size region, these pixels being horizontally aligned in a row, similarly to the row data illustrated in FIG. 2. It should be noted that, although in this example the direction of the row is the horizontal direction, the arrangement of the pixels in each row is not limited to the horizontal direction. For example, it may be set in a different direction (e.g., a vertical direction) according to the specifications of the video signal processing device.

Now, consider a case where n=8, m=4, k=1, the effective pixel group 211a monotonously increases, and the adjustment subject pixel group 211b is 0, for example, the row data 211=[70 85 120 150 0 0 0 0]. In this case, 150 (=X₄) is stored in the temporary memory 120a of the picture adjustment section 120. The data obtained after compression and expansion results in [67 80 141 143 10 −16 9 −6], in which 143 (=X₄) is then replaced with 150 stored in the temporary memory 120a. The result of this adjustment is [67 80 141 150 10 −16 9 −6], whereas the conventional process without adjustment would result in [67 79 141 143 11 0 8 0] after compression and expansion. As a result, the error from the effective pixel group 211a [70 85 120 150] is [−3 −6 21 0] in embodiment 13, whereas [−3-6 21 −7] in the conventional process. This result confirms that adjustment of the trailing end pixels of the effective pixel group provides the effect of improving the picture quality.

It should be noted that although in the above example one pixel is replaced but the present invention is not thereto. For example, two or more pixels may be replaced according to the specifications of the video signal processing device.

According to the present invention, various effective video sizes of moving picture data can be processed in such a manner that deterioration in picture quality of compressed moving picture data is suppressed without causing significant increase in circuit size. For example, the present invention is useful for a video signal processing device which performs a decoding process with a reduced memory size.

What is claimed is:

1. A video signal processing device, comprising:
a video signal processing section for decoding encoded moving picture data;
a picture adjustment section for performing an adjustment process on moving picture data output from the video signal processing section;
a picture compression section for compressing moving picture data adjusted by the picture adjustment section; and
a picture expansion section for expanding moving picture data compressed by the picture compression section, wherein
if the moving picture data divided by a compression process size includes an effective video size region and a region other than the effective video size region, the picture adjustment section performs an adjustment on a pixel outside the effective video size region using a pixel inside the effective video size region.

2. The video signal processing device of claim 1, wherein the picture adjustment section performs the adjustment process on a row-by-row basis where each row includes a group of effective pixels inside the effective video size region and a group of adjustment subject pixels outside the effective video size region, these pixels being horizontally or vertically aligned in a row.

3. The video signal processing device of claim 2, wherein the picture adjustment section replaces the adjustment subject pixel group with a trailing end pixel of the effective pixel group.

4. The video signal processing device of claim 2, wherein the picture adjustment section performs the adjustment on the adjustment subject pixel group by symmetric interpolation of the effective pixel group symmetrically about a border between the effective pixel group and the adjustment subject pixel group.

5. The video signal processing device of claim 2, wherein:
the picture adjustment section adjusts a pixel of the adjustment subject pixel group which is adjacent to the effective pixel group to 2Xₘ−Xₘ₋₁ (Xₘ₋₁ and Xₘ are two trailing end pixels of the effective pixel group); and
the picture adjustment section adjusts remaining pixels of the adjustment subject pixel group by symmetric interpolation of the effective pixel group symmetrically about the adjusted pixel.

6. The video signal processing device of claim 2, wherein the picture adjustment section adjusts the adjustment subject pixel group by symmetric interpolation of the effective pixel group symmetrically about a trailing end pixel of the effective pixel group.

7. The video signal processing device of claim 2, wherein:
the picture adjustment section adjusts a pixel of the adjustment subject pixel group which is adjacent to the effective pixel group to have a value calculated using a function based on k trailing end pixels of the effective pixel group (k is an integer equal to or greater than 3); and
the picture adjustment section adjusts remaining pixels of the adjustment subject pixel group by symmetric interpolation symmetrically about the adjusted pixels.

8. The video signal processing device of claim 7, wherein the picture adjustment section includes a register for storing a coefficient of the function.

9. The video signal processing device of claim 2, wherein the picture adjustment section replaces the adjustment subject pixel group with the effective pixel group in the original order.

10. The video signal processing device of claim 2, wherein:
the picture adjustment section includes a register for storing an adjustment value; and
the picture adjustment section adjusts the adjustment subject pixel group to have the adjustment value stored in the register.

11. The video signal processing device of claim 2, wherein:
the picture adjustment section includes a register for storing an adjustment value;
the picture adjustment section calculates a pixel average value of the effective pixel group; and
the picture adjustment section adjusts the adjustment subject pixel group to have a value obtained by adding the adjustment value of the register to the pixel average value.

12. The video signal processing device of claim 2, wherein the picture adjustment section uses two rows precedent to a row which is currently subjected to the adjustment process to adjust each pixel of the adjustment subject pixel group to be equal to an average of 2Xₗ−Xₗ₋₁ and 2Xₚ−Xₚ₋₁ (Xₗ₋₁ and Xₗ represent two preceding pixels in the current row, Xₚ represents a pixel at an intersection of an immediately preceding row and an immediately preceding column, and Xₚ₋₁ represents a pixel at an intersection of a second preceding row and a second preceding column).

13. The video signal processing device of claim 2, wherein the picture adjustment section uses two preceding rows and two subsequent rows of a row which is currently subjected to the adjustment process to adjust each pixel of the adjustment subject pixel group to be equal to an average of 2Xₗ−Xₗ₋₁, 2Xₚ−Xₚ₋₁ and 2X_{q}−X_{q-1} (Xₗ₋₁ and Xₗ represent two preceding pixels in the current row, Xₚ represents a pixel at an intersection of an immediately preceding row and an immediately preceding column, Xₚ₋₁ represents a pixel at an intersection of a second preceding row and a second preceding column, X_{q} represents a pixel at an intersection of an immediately subsequent row and an immediately preceding column, and X_{q-1} represents a pixel at an intersection of a second subsequent row and a second preceding column).

14. The video signal processing device of claim 2, wherein:
the picture adjustment section uses two rows precedent to a row which is currently subjected to the adjustment process to adjust a pixel of the adjustment subject pixel group which is adjacent to the effective pixel group to be equal to an average of 2Xₗ−Xₗ₋₁ and 2Xₚ−Xₚ₋₁ (Xₗ₋₁ and Xₗ represent two preceding pixels in the current row, Xₚ represents a pixel at an intersection of an immediately preceding row and an immediately preceding column, and Xₚ₋₁ represents a pixel at an intersection of a second preceding row and a second preceding column); and
the picture adjustment section adjusts remaining pixels of the adjustment subject pixel group by symmetric interpolation symmetrically about the adjusted pixel.

15. The video signal processing device of claim 2, wherein:
the picture adjustment section uses two preceding rows and two subsequent rows of a row which is currently subjected to the adjustment process to adjust a pixel of the adjustment subject pixel group which is adjacent to the effective pixel group to be equal to an average of 2Xₗ−Xₗ₋₁, 2Xₚ−Xₚ₋₁ and 2X_{q}−X_{q-1} (Xₗ₋₁ and Xₗ represent two preceding pixels in the current row, Xₚ represents a pixel at an intersection of an immediately preceding row and an immediately preceding column, Xₚ₋₁ represents a pixel at an intersection of a second preceding row and a second preceding column, X_{q} represents a pixel at an intersection of an immediately subsequent row and an immediately preceding column, and X_{q-1} represents a pixel at an intersection of a second subsequent row and a second preceding column); and
the picture adjustment section adjusts remaining pixels of the adjustment subject pixel group by symmetric interpolation symmetrically about the adjusted pixel.

16. The video signal processing device of claim 1, wherein the picture compression section and the picture expansion section perform processes using frequency conversion.

17. A video signal processing device, comprising:
a video signal processing section for decoding encoded moving picture data;
a picture compression section for compressing moving picture data output from the video signal processing section;
a picture expansion section for expanding moving picture data compressed by the picture compression section, and
a picture adjustment section for performing an adjustment process on moving picture data output from the picture expansion section while referring to moving picture data output from the video signal processing section, wherein
if the moving picture data divided by a compression process size and output from the video signal processing section includes an effective video size region and a region other than the effective video size region, the picture adjustment section stores in a temporary memory k pixels inside the effective video size region adjacent to a border with the region other than the effective video size region (k is a positive integer): and
the picture adjustment section performs the adjustment process on the moving picture data output from the picture expansion section such that the k pixels stored in the temporary memory substitute for corresponding pixels of the moving picture data.
